(19) United States
(12) Patent Application Publication
(10) Pub. No.: US 2014/0220407 A1
(43) Pub. Date: Aug. 7, 2014

(54) Method of Manufacturing Solid Type Secondary Battery and Solid Type Secondary Battery Based on the Same

(71) Applicants: Shoji Ichimura, Shizuoka (JP); Fukuyo Ichimura, Shizuoka (JP)

(72) Inventors: Shoji Ichimura, Shizuoka (JP); Fukuyo Ichimura, Shizuoka (JP)

(21) Appl. No.: 13/583,051

(22) PCT Filed: May 24, 2012
(86) PCT No.: PCT/JP2012/063287

§ 371 Date: Sep. 6, 2012

(30) Foreign Application Priority Data
Sep. 9, 2011 (JP) 2011-196669

(51) Int. Cl. H01M 10/0585

(52) U.S. Cl. CPC H01M 10/0585
USPC 429/124; 29/623.5

(57) ABSTRACT

A method of manufacturing a solid type secondary battery and a solid type secondary battery manufactured using the same, in which positive and negative electrodes include silicon carbide and silicon nitride, nonaqueous electrolyte includes ion exchange resin or ion exchange inorganic substance, the method including the steps of manufacturing a positive electrode print layer 2, a negative electrode print layer 3, and a nonaqueous electrolyte print layer 4 by mixing each pigment powder of 100 parts by weight for materials of the positive electrode layer, the negative electrode layer, and the nonaqueous electrolyte layer with water-soluble silicon resin of 1 to 50 parts by weight and water of 10 to 100 parts by weight; sequentially performing layered printing for each print layer; and drying the stack.

### FIELD OF THE INVENTION

This disclosure relates to a solid type secondary battery obtained by using silicon nitride and silicon carbide in an electrode and a method of manufacturing the solid type secondary battery using a printing technique.

### BACKGROUND OF THE INVENTION

In Japanese Unexamined Patent Application No. 2010-168403, the inventors proposed a solid type secondary battery configuration in which silicon carbide (defined by a chemical formula of SiC) is used at a positive electrode, silicon nitride (defined by a chemical formula of Si₃N₄) is used at a negative electrode, and a nonaqueous electrolyte including ion exchange resin or an ion exchange inorganic substance is interposed therebetween, which has been already established as Japanese Patent No. 4685192 (hereinafter, simply referred to as “Prior Art 1”).

Furthermore, in Japanese Unexamined Patent Application No. 2010-285293, the inventors proposed a solid type secondary battery configuration in which silicon nitride (defined by a chemical formula of Si₂N₃) is used at a positive electrode, silicon carbide (defined by a chemical formula of Si₂C) is used at a negative electrode, and a nonaqueous electrolyte including ion exchange resin or an ion exchange inorganic substance is interposed therebetween, which has been already established as Japanese Patent No. 4800440 (hereinafter, simply referred to as “Prior Art 2”).

Prior Arts 1 and 2 have a lot of advantages in that a voltage generation corresponding to that of the solid type secondary battery in which lithium is used at the negative electrode can be obtained with low cost while no environmental problem occurs compared to the lithium battery even when the battery is discarded.

In embodiments regarding the method of manufacturing the solid type secondary battery in Prior Arts 1 and 2, a positive electrode charge-collecting layer and a negative electrode charge-collecting layer are formed through metal sputtering in advance, compounds of each electrode are deposited on the charge-collecting layers in vacuum, and a positive or negative electrode layer is coated so as to form the nonaqueous electrolyte layer.

Needless to say, the manufacturing method described above is not satisfactory from the viewpoint of work efficiency. Meanwhile, in Publication of Unexamined Patent Application No. H11-67236 and Patent Gazette No. 4295617, there is proposed a solid type secondary battery in which the nonaqueous electrolyte layer is formed through printing. However, they fail to propose a configuration for forming the positive electrode and the negative electrode through printing.

### PATENT LITERATURE

[Patent Literature 1] Publication of Unexamined Patent Application No. H 11-67236
[Patent Literature 2] Patent Gazette No. 4295617

### SUMMARY OF THE INVENTION

### Problems to be Solved by the Invention

Thus, a need exists for a method of manufacturing a solid type secondary battery through printing in which silicon carbide and silicon nitride are used at positive and negative electrodes, and ion exchange resin or an ion exchange inorganic substance is used in nonaqueous electrolyte, and a solid type secondary battery manufactured using the same.

### Solutions to Problems

In order to address the problems described above, the basic configuration of the present invention is:

1. A method of manufacturing a solid type secondary battery that generates a silicon cation (Si⁺) at a positive electrode and a silicon anion (Si⁻) at a negative electrode in charging. The method includes (1) a process of manufacturing a positive electrode print layer, a negative electrode print layer, and a nonaqueous electrolyte print layer by mixing positive electrode pigment powder defined by a chemical formula of silicon carbide (SiC) of 100 parts by weight, negative electrode pigment powder defined by a chemical formula of silicon nitride (Si₃N₄) of 100 parts by weight and nonaqueous electrolyte pigment powder formed by ion exchange resin of 100 parts by weight which contains either one or more of polymers having a sulfonic acid group (—SO₃H), a carboxyl group (—COOH), an anionic quaternary ammonium group (—N(CH₃)₂C₂H₄OH), or a substituted amino group (—NH(CH₃)₂) as a linking group respectively, with a binder of water-soluble silicon resin of 1 to 50 parts by weight and a water-based solvent to 10 to 100 parts by weight; (2) a process of sequentially performing layered printing in the sequence of the positive electrode print layer, the nonaqueous electrolyte print layer, and the negative electrode print layer or in the sequence of the negative electrode print layer, the nonaqueous electrolyte print layer, and the positive electrode print layer; and (3) a process of drying a stack obtained through the layered printing of the process (2).
2. A method of manufacturing a solid type secondary battery that generates silicon cation (Si⁺) at a positive electrode and silicon anion (Si⁻) at a negative electrode in charging. The method includes (1) a process of manufacturing a positive electrode print layer, a negative electrode print layer, and a nonaqueous electrolyte print layer by mixing positive electrode pigment powder defined by a chemical formula of silicon carbide (SiC) of 100 parts by weight, negative electrode pigment powder defined by a chemical formula of silicon nitride (Si₃N₄) of 100 parts by weight and nonaqueous electrolyte pigment powder formed by an ion inorganic substance of 100 parts by weight which includes tin chloride (SnCl₃), a solid solution of zirconium magnesium oxide (ZrMgO₃), a solid solution of calcium zirconium oxide (ZrCaO₃), zirconium oxide (ZrO₂), silicon-betaalumina (Al₂O₃), silicon carbon oxynitride (SiCON), or silicon zirconium phosphate (Si₂Zr₂PO) respectively, with a binder of water-soluble silicon resin of 1 to 50 parts by weight, and a water-based solvent to 10 to 100 parts by weight and a water-based solvent of 10 to 100 parts by weight; (2) a process of sequentially performing layered printing in the sequence of the positive electrode print layer, the nonaqueous electrolyte print layer, and the negative electrode print layer or in the sequence of the negative electrode print layer, the nonaqueous electrolyte print layer, and the positive electrode print layer; and (3) a process of drying a stack obtained through the layered printing of the process (2).
3. A method of manufacturing a solid type secondary battery in which, at a negative electrode, a silicon cation (Si⁺) and an electrons (e⁻) are discharged, and at a positive electrode, nitrogen molecules (N₂) and oxygen molecules (O₂) in the air are chemically bonded with silicon nitride (Si₂N₃), the silicon cation (Si⁺) and the electrons (e⁻) which are transferred from the negative electrode in discharging, while at a negative electrode, a silicon cation (Si⁺) and an electrons (e⁻) are absorbed, and at a positive electrode, the chemical bonding of the nitrogen molecules and the oxygen molecules is broken, and the nitrogen molecules and the oxygen molecules are discharged into the air. The method includes (1) a process of manufacturing a positive electrode print layer, a negative electrode print layer, and a nonaqueous electrolyte print layer by mixing positive electrode pigment powder defined by a chemical formula of silicon nitride (Si₂N₃) of 100 parts by weight, negative electrode pigment powder defined by a chemical formula of silicon carbide (Si₂C) of 100 parts by weight and nonaqueous electrolyte pigment powder formed by ion exchange resin of 100 parts by weight which contains either one or more of polymers having a sulfonic acid group (—SO₃H), a carboxyl group (—COOH), an anionic quaternary ammonium group (—N(CH₃)₂C₂H₄OH), or a substituted amino group (—NH(CH₃)₂) as a linking group respectively, with a binder of water-soluble silicon resin of 1 to 50 parts by weight and a water-based solvent to 10 to 100 parts by weight; (2) a process of sequentially performing layered printing in the sequence of the positive electrode print layer, the nonaqueous electrolyte print layer, and the negative electrode print layer or in the sequence of the negative electrode print layer, the nonaqueous electrolyte print layer, and the positive electrode print layer; and (3) a process of drying a stack obtained through the layered printing of the process (2).
4. A method of manufacturing a solid type secondary battery in which, at a negative electrode, a silicon cation (Si⁺) and an electrons (e⁻) are discharged, and at a positive electrode, nitrogen molecules (N₂) and oxygen molecules (O₂) in the air are chemically bonded with silicon nitride (Si₂N₃), the silicon cation (Si⁺) and the electrons (e⁻) which are transferred from the negative electrode in discharging, while at a negative electrode, a silicon cation (Si⁺) and an electrons (e⁻) are absorbed, and at a positive electrode, the chemical bonding of the nitrogen molecules and the oxygen molecules is broken, and the nitrogen molecules and the oxygen molecules are discharged into the air. The method includes (1) a process of manufacturing a positive electrode print layer, a negative electrode print layer, and a nonaqueous electrolyte print layer by mixing positive electrode pigment powder defined by a chemical formula of silicon nitride (Si₂N₃) of 100 parts by weight, negative electrode pigment powder defined by a chemical formula of silicon carbide (Si₂C) of 100 parts by weight and nonaqueous electrolyte pigment powder formed by an ion inorganic substance of 100 parts by weight which includes tin chloride (SnCl₃), a solid solution of zirconium magnesium oxide (ZrMgO₃), a solid solution of calcium zirconium oxide (ZrCaO₃), zirconium oxide (ZrO₂), silicon-betaalumina (Al₂O₃), silicon carbon oxynitride (SiCON), or silicon zirconium phosphate (Si₂Zr₂PO) respectively, with a binder of water-soluble silicon resin of 1 to 50 parts by weight, and a water-based solvent to 10 to 100 parts by weight and a water-based solvent of 10 to 100 parts by weight; (2) a process of sequentially performing layered printing in the sequence of the positive electrode print layer, the nonaqueous electrolyte print layer, and the negative electrode print layer or in the sequence of the negative electrode print layer, the nonaqueous electrolyte print layer, and the positive electrode print layer; and (3) a process of drying a stack obtained through the layered printing of the process (2).
5. A solid type secondary battery manufactured by either one of the methods 1-4 described above.

### Advantages of the Invention

According to the first to fifth aspects of the disclosure, it is possible to efficiently manufacture the solid type secondary battery by stacking each print layer.

In addition, the binder is water-soluble so as to have a predetermined polarity. Therefore, it is possible to alleviate a degree of degrading the conductability based on the polarity of the nonaqueous electrolyte when the binder remains after the drying.

In addition, water-soluble silicon resin is employed as a printing binder, and water is employed as a solvent. As a result, since water is evaporated in the drying process, it is possible to prevent a disadvantage of conductivity degradation in each print layer caused by the remaining organic solvent even after the drying unlike the case where the organic solvent is used.

In addition, since the binder contains water-soluble silicon resin, silicon carbide and silicon nitride as materials of the positive electrode pigment powder and the negative electrode pigment powder can be uniformly dissolved.

### BRIEF DESCRIPTION OF THE DRAWINGS

FIG. 1A illustrates a chemical structure of silicon rubber, and FIG. 1B illustrates a chemical structure of silicon resin (silicon varnish);

FIG. 2 is a cross-sectional view illustrating a print process in a method of manufacturing a solid type secondary battery according to the first to fourth aspects; and

FIG. 3 is a graph illustrating charge/discharge behavior in the examples.

### DETAILED DESCRIPTION OF THE INVENTION

According to this disclosure, as in the process (2) of the first to fourth aspects, the layers are stacked through printing in the sequence of the positive electrode print layer 2, the nonaqueous electrolyte print layer 4, and the negative electrode print layer 3, or in the reversed sequence thereof while, as in the process (1), water-soluble silicon resin is employed as a binder, and water is employed as a solvent in each print layer.

Technical advantages in employing the binder and the solvent have been already described in conjunction with advantages of the invention.

In any case of the first to fifth aspects, the positive electrode, the negative electrode and a pigment powder which contains nonaqueous electrolyte is supposed to be set to 100 parts by weight, a binder of water-soluble silicon resin is set to 1 to 50 parts by weight, and a water-based solvent is set to 10 to 100 parts by weight.

Considering the aforementioned mixture proportions, if the weight percentage of the water-soluble silicon resin exceeds 50 parts by weight, the percentages of the materials of the positive electrode, the negative electrode, and the nonaqueous electrolyte are reduced after the solid type secondary battery is formed through layered printing, so that charge/discharge behavior of each electrode and the conductability of the nonaqueous electrolyte may become insufficient.

In comparison, if the weight percentage of the water-soluble silicon resin is smaller than 1 parts by weight, a bonding force between materials may be insufficient when the positive electrode, the negative electrode, and the nonaqueous electrolyte layer are formed, so that it may be difficult to obtain a sufficient mechanical strength in some cases.

That is, the weight percentage of the binder is set based on a tradeoff relationship between the charge/discharge capability and conductability and the mechanical strength. However, if the mixture proportion of the water-soluble silicon resin in each print layer is set to 10 parts by weight, that is, if each pigment powder is contained in each print layer by approximately 91 wt %, it is possible to reliably establish the tradeoff relationship.

The proportion of the water-based solvent is set to 10 to 100 parts by weight because it is considered to be an appropriate range in order to dissolve the water-soluble silicon resin by a mixture proportion of 1 to 50 parts by weight and enable each pigment powder to be removed.

Specifically, this is based on a fact that printable ink can be formed by mixing each of the aforementioned pigment powder within a range from the thickest binder state, in which a mixture of 101 parts by weight is obtained by maximizing the amount of the water-soluble silicon resin and minimizing the amount of water, to the thinnest binder state, in which a mixture of 60 (=50+10) parts by weight is obtained by maximizing the amount of water-soluble silicon resin and minimizing the amount of water.

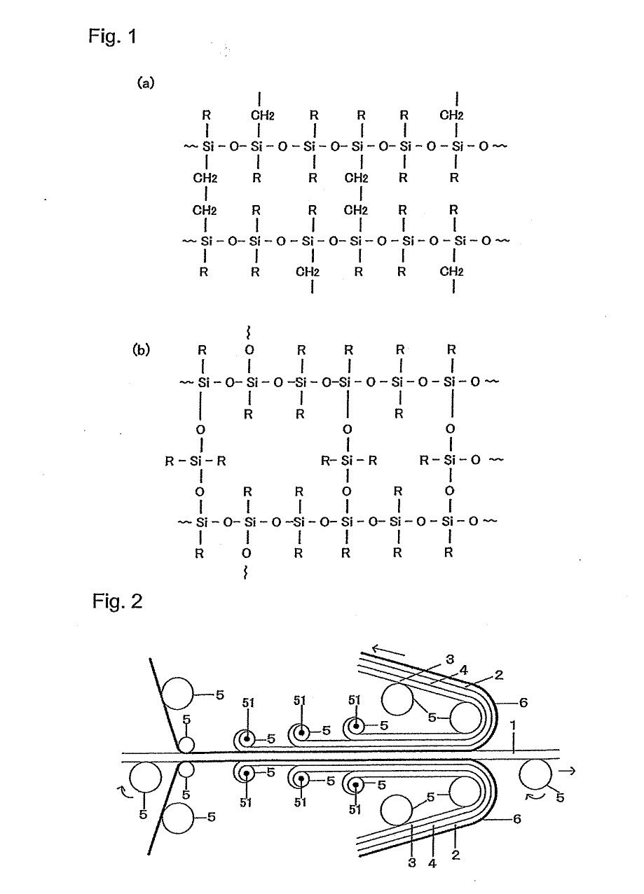

Although silicon resin is employed in a variety of fields in recent years, a basic chemical formula in condensation polymerization reaction is expressed as (RₙSiO_{(4-n)/2})ₘ (while R may be selected from a plurality of types of elements or linking groups and is typically selected from linking groups of organic compounds, it is not limited to the linking groups of organic compounds in the case of water-soluble silicon rubber as described below). In addition, the case of silicon rubber is illustrated in FIG. 1A, and the case of silicon resin (silicon varnish) is illustrated in FIG. 1B (as described above, R may be selected from a plurality of types of elements or linking groups).

In general, the water-soluble silicon resin may be implemented by selecting a hydrogen atom (H) for ½ or more of the R in the aforementioned general formula. In particular, as the water-soluble silicon resin, siloxane having a SiH bonding may be used. Preferably, a part of the hydrogen bonding in the aforementioned bonding are substituted with halogen atoms of chlorine (Cl), bromine (Br), or fluorine (F) or alkali metals of sodium (Na) or potassium (K). Alternatively, in the aforementioned bonding, ½ or less of hydrogen may be substituted with linking groups of organic compounds.

If a conductive filler is mixed in the nonaqueous electrolyte print layer 4 according to an embodiment, it is possible to obtain excellent conductivity in the nonaqueous electrolyte print layer 4.

As the conductive filler, metallic impalpable powder, conductive carbon black powder, or carbon fiber powder may be employed in any typical example.

As the printing method according to the first to fourth aspects, any typical printing example such as screen printing, planographic printing, gravure printing, and flexographic printing may be employed without limitation.

In order to efficiently implement the layered printing, it is preferable that each print layer separated from each roller 5 be stacked on both sides of the release sheet 1 moved by the roller 5 as illustrated in FIG. 2.

In the case of the positive electrode print layer 2, the negative electrode print layer 3, and the nonaqueous electrolyte print layer 4, the print layers having predetermined thicknesses are formed by injecting ink for forming such print layers from a rotational center of the roller and the vicinity area 51 and sequentially discharging the ink from the surface of the roller 5 while they leave the roller 5.

According to the aforementioned embodiment illustrated in FIG. 2, in order to facilitate exfoliation from the release sheet in each of the stacked print layers, first, the aluminum thin film 6 may be arranged in both sides of the release sheet 1, and further, the print layers may be stacked on both outer sides thereof in the sequence of the process (2) according to the first to fourth aspects.

In the practical solid type secondary battery, in order to prevent a breakdown or damage of the positive and negative electrodes, a positive electrode charge-collecting layer and a negative electrode charge-collecting layer are formed in each of the outer sides of the both electrodes in many cases.

In order to form each of the charge-collecting layers, according to a preferable embodiment in this disclosure, typically, the mixture proportion is set to contain graphite powder or graphite fiber powder of 100 parts by weight, a binder of water-soluble silicon resin of 1 to 50 parts by weight, and a water-based solvent of 10 to 100 parts by weight, and each of positive and negative electrode charge-collecting print layers is manufactured by mixing graphite powder or graphite fiber powder with the binder and the solvent described above. Moreover, in the printing process (2), the positive electrode charge-collecting print layer is printed on the outer side of the positive electrode print layer 2, and the negative electrode charge-collecting print layer is printed on the outer side of the negative electrode print layer 3 to protect the positive and negative electrodes.

In the case where the aforementioned embodiment is employed in a printing type in which printing is performed on both sides of the release sheet, the positive or negative electrode charge-collecting layer serves as a target of the initial print layer.

In the drying process (3) according to the first to fourth aspects, any of natural drying, baking, or forced-air drying may be employed.

The disclosure is not limited by the thickness of each print layer. However, typically, after the drying process (3), the positive electrode print layer 2 and the negative electrode print layer 3 have a thickness of 10 to 20 μm, the nonaqueous electrolyte print layer 4 has a thickness of 50 to 150 μm, and the positive electrode charge-collecting print layer and the negative electrode charge-collecting print layer have a thickness of 5 to 10 μm in many cases.

Hereinafter, embodiment of the disclosure will be described.

### Embodiment

Each print layer was formed as described below according to the second aspect.

Positive electrode print layer: silicon carbide pigment powder (defined by a chemical formula of SiC) of 100 parts by weight, water-soluble silicon rubber of 1 parts by weight based on siloxane of which overall linking groups have the SiH bonding, and water of 10 parts by weight.

Negative electrode print layer: pigment powder (defined by a chemical formula of Si₃N₄) of 100 parts by weight, the aforementioned water-soluble silicon rubber of 1 parts by weight, and water of 10 parts by weight.

Nonaqueous electrolyte print layer: zirconium oxide (ZrO₂) pigment powder 100 parts by weight, the aforementioned water-soluble silicon rubber of 1 parts by weight, and water of 10 parts by weight.

Positive and negative electrode charge-collecting layer: carbon graphite pigment powder of 100 parts by weight, the aforementioned water-soluble silicon rubber of 1 parts by weight, and water of 10 parts by weight.

For each of the five print layers described above, the aforementioned layered printing (2) was performed on both sides of the release sheet as illustrated in FIG. 2, and then, the drying process (3) was performed through natural drying. As a result, it was possible to obtain a solid type secondary battery including positive and negative electrode layers having a thickness of 20 μm, a nonaqueous electrolyte layer having a thickness of 100 μm, and positive and negative electrode charge-collecting layers having a thickness of 10 μm.

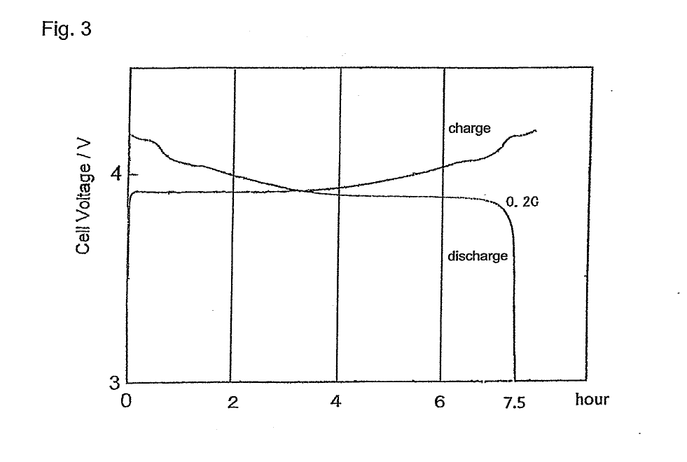

The aforementioned solid type secondary battery was charged using a constant current source capable of providing a current density of 0.9 A/cm². As indicated by the curve of FIG. 3 which rises as time elapses, a voltage range of approximately 3.5 to 5.5 V can be maintained for approximately 7.5 hours. Then, the solid type secondary battery was discharged. As indicated by the curve of FIG. 3 which falls as time elapses, a voltage range of approximately 5.5 to 3.5 V can be maintained for approximately 7 hours.

In this manner, if the water-soluble silicon resin is employed as a binder, and water is employed as a solvent, it was recognized that the solid type secondary battery is normally operated in the second aspect based on Prior Art 1. In Prior Art 1, considering a fact that charging of a voltage range of approximately 4 to 5.5 V is maintained for approximately 40 hours, and discharging of approximately 4 to 3.5V is maintained for approximately 35 hours if ion exchange resin is employed as the nonaqueous electrolyte, it is possible to anticipate that a charge/discharge behavior similar to that of the aforementioned example of the second aspect can be obtained in the case of the first aspect. Furthermore, even in the example of Prior Art 2, considering a fact that a charge/discharge behavior similar to that of Prior Art 1 can be obtained if ion exchange resin is employed as the nonaqueous electrolyte, it is possible to sufficiently anticipate that a charge/discharge behavior similar to that of the aforementioned example of the second aspect can be obtained even in the third and fourth aspects.

In comparison, it is doubtful that the excellent charge/discharge behavior described above could be obtained if other polymer is employed as a binder, and an organic solvent is employed as a solvent. In this meaning, use of the water-soluble silicon resin and water is innovative.

### INDUSTRIAL APPLICABILITY

The method of manufacturing the solid type secondary battery according to this disclosure provides an efficient manufacturing method in the field of the solid type secondary battery manufacturing of Prior Arts 1 and 2. The method may be sufficiently utilized also in a personal computer (PC), a mobile phone, and storage of electric energy based on natural energy such as solar, wind, or ocean tide energy.

### DESCRIPTION OF SYMBOLS

1 RELEASE SHEET
2 POSITIVE ELECTRODE PRINT LAYER
3 NEGATIVE ELECTRODE PRINT LAYER
4 NONAQUEOUS ELECTROLYTE PRINT LAYER
5 ROLLER
51 ROTATIONAL CENTER OF ROLLER AND VICINITY AREA
6 ALUMINUM THIN FILM

What is claimed is:

1. A method of manufacturing a solid type secondary battery that generates a silicon cation (Si⁺) at a positive electrode and a silicon anion (Si⁻) at a negative electrode in charging, the method comprising the steps of:
(1) a step of manufacturing a positive electrode print layer, a negative electrode print layer, and a nonaqueous electrolyte print layer by mixing positive electrode pigment powder defined by a chemical formula of silicon carbide (SiC) of 100 parts by weight, negative electrode pigment powder defined by a chemical formula of silicon nitride (Si₃N₄) of 100 parts by weight and nonaqueous electrolyte pigment powder formed by ion exchange resin of 100 parts by weight which contains at least one polymer selected from the group having a sulfonic acid group (—SO₃H), a carboxyl group (—COOH), an anionic quaternary ammonium group (—N(CH₃)₂C₂H₄OH), or a substituted amino group (—NH(CH₃)₂) as a linking group respectively, with a binder of water-soluble silicon resin of 1 to 50 parts by weight and a water-based solvent to 10 to 100 parts by weight;
(2) a step of sequentially performing layered printing in the sequence of one of the following:
a) the positive electrode print layer, the nonaqueous electrolyte print layer, and the negative electrode print layer, and
b) the negative electrode print layer, the nonaqueous electrolyte print layer, and the positive electrode print layer; and
(3) a step of drying a stack obtained through the layered printing of the step (2).

2. A method of manufacturing a solid type secondary battery that generates silicon cation (Si⁺) at a positive electrode and silicon anion (Si⁻) at a negative electrode in charging, the method comprising the steps of:
(1) a step of manufacturing a positive electrode print layer, a negative electrode print layer, and a nonaqueous electrolyte print layer by mixing positive electrode pigment powder defined by a chemical formula of silicon carbide (SiC) of 100 parts by weight, negative electrode pigment powder defined by a chemical formula of silicon nitride (Si₃N₄) of 100 parts by weight and nonaqueous electrolyte pigment powder formed by an ion inorganic substance of 100 parts by weight which includes a composition selected from the group consisting of tin chloride (SnCl₃), a solid solution of zirconium magnesium oxide (ZrMgO₃), a solid solution of calcium zirconium oxide (ZrCaO₃), zirconium oxide (ZrO₂), silicon-betaalumina (Al₂O₃), silicon carbon oxynitride (SiCON), and silicon zirconium phosphate (Si₂Zr₂PO) respectively, with a binder of water-soluble silicon resin of 1 to 50 parts by weight, and a water-based solvent to 10 to 100 parts by weight and a water-based solvent of 10 to 100 parts by weight;
(2) a step of sequentially performing layered printing in the sequence of one of the following:
a) the positive electrode print layer, the nonaqueous electrolyte print layer, and the negative electrode print layer, and
b) the negative electrode print layer, the nonaqueous electrolyte print layer, and the positive electrode print layer; and
(3) a step of drying a stack obtained through the layered printing of the step (2).

3. A method of manufacturing a solid type secondary battery in which, at a negative electrode, a silicon cation (Si⁺) and an electrons (e⁻) are discharged, and at a positive electrode, nitrogen molecules (N₂) and oxygen molecules (O₂) in the air are chemically bonded with silicon nitride (Si₂N₃), the silicon cation (Si⁺) and the electrons (e⁻) which are transferred from the negative electrode in discharging, while at a negative electrode, a silicon cation (Si⁺) and the electrons (e⁻) are absorbed, and at a positive electrode, the chemical bonding of the nitrogen molecules and the oxygen molecules is broken, and the nitrogen molecules and the oxygen molecules are discharged into the air, the method comprising the steps of:
(1) a step of manufacturing a positive electrode print layer, a negative electrode print layer, and a nonaqueous electrolyte print layer by mixing positive electrode pigment powder defined by a chemical formula of silicon nitride (Si₂N₃) of 100 parts by weight, negative electrode pigment powder defined by a chemical formula of silicon carbide (Si₂C) of 100 parts by weight and nonaqueous electrolyte pigment powder formed by ion exchange resin of 100 parts by weight which contains at least one polymer selected from the group having a sulfonic acid group (—SO₃H), a carboxyl group (—COOH), an anionic quaternary ammonium group (—N(CH₃)₂C₂H₂OH), or a substituted amino group (—NH(CH₃)₂) as a linking group respectively, with a binder of water-soluble silicon resin of 1 to 50 parts by weight and a water-based solvent to 10 to 100 parts by weight;
(2) a step of sequentially performing layered printing in the sequence of one of the following:
a) the positive electrode print layer, the nonaqueous electrolyte print layer, and the negative electrode print layer, and
b) the negative electrode print layer, the nonaqueous electrolyte print layer, and the positive electrode print layer; and
(3) a step of drying a stack obtained through the layered printing of the step (2).

4. A method of manufacturing a solid type secondary battery in which, at a negative electrode, a silicon cation (Si⁺) and electrons (e⁻) are discharged, and at a positive electrode, nitrogen molecules (N₂) and oxygen molecules (O₂) in the air are chemically bonded with silicon nitride (Si₂N₃), the silicon cation (Si⁺) and the electrons (e⁻) which are transferred from the negative electrode in discharging, while at a negative electrode, a silicon cation (Si⁺) and the electrons (e⁻) are absorbed, and at a positive electrode, the chemical bonding of the nitrogen molecules and the oxygen molecules is broken, and the nitrogen molecules and the oxygen molecules are discharged into the air, the method comprising the steps of:
(1) a step of manufacturing a positive electrode print layer, a negative electrode print layer, and a nonaqueous electrolyte print layer by mixing positive electrode pigment powder defined by a chemical formula of silicon nitride (Si₂N₃) of 100 parts by weight, negative electrode pigment powder defined by a chemical formula of silicon carbide (Si₂C) of 100 parts by weight and nonaqueous electrolyte pigment powder formed by an ion inorganic substance of 100 parts by weight which includes composition selected from the group consisting of tin chloride (SnCl₃), a solid solution of zirconium magnesium oxide (ZrMgO₃), a solid solution of calcium zirconium oxide (ZrCaO₃), zirconium oxide (ZrO₂), silicon-betaalumina (Al₂O₃), silicon carbon oxynitride (SiCON), and silicon zirconium phosphate (Si₂Zr₂PO) respectively, with a binder of water-soluble silicon resin of 1 to 50 parts by weight, and a water-based solvent to 10 to 100 parts by weight and a water-based solvent of 10 to 100 parts by weight;
(2) a step of sequentially performing layered printing in the sequence of one of the following:
a) the positive electrode print layer, the nonaqueous electrolyte print layer, and the negative electrode print layer, and
b) the negative electrode print layer, the nonaqueous electrolyte print layer, and the positive electrode print layer; and
(3) a step of drying a stack obtained through the layered printing of the step (2).

5. The method of manufacturing a solid type secondary battery according claim 1, wherein the water-soluble silicon resin includes one of:
siloxane having a SiH bonding and
a compound obtained by one of:
substituting a part of hydrogen in the bonding with halogen atoms of chlorine (Cl), bromine (Br), or fluorine (F) or alkali metals of sodium (Na) or potassium (K), or and
substituting ½ or less of hydrogen in the bonding with a linking group of an organic compound.

6. The method of manufacturing a solid type secondary battery according to claim 1, further comprising a step of manufacturing a positive electrode charge-collecting print layer and a negative electrode charge-collecting print layer by mixing one of graphite powder and graphite fiber powder of 100 parts by weight with a binder of water-soluble silicon resin of 1 to 50 parts by weight and a water-based solvent of 10 to 100 parts by weight, wherein, in the printing step (2), the positive electrode charge-collecting print layer is printed on an outer side of the positive electrode print layer, and the negative electrode charge-collecting print layer is printed on an outer side of the negative electrode print layer.

7. The method of manufacturing a solid type secondary battery according to claim 1, further including the step of mixing a conductive filler in the nonaqueous electrolyte print layer.

8. The method of manufacturing a solid type secondary battery according to claim 1, wherein each of the print layers separated between rollers is stacked on both sides of a release sheet moved by a roller.

9. The method of manufacturing a solid type secondary battery according to claim 6, wherein after the drying step (3), the positive and negative electrode print layers have a thickness of 10 to 20 mm, the nonaqueous electrolyte print layer has a thickness of 50 to 150 mm, and the positive and negative charge-collecting print layers have a thickness of 5 to 10 mm.

10. A solid type secondary battery manufactured by the method according to claim 1.

11. The method of manufacturing a solid type secondary battery according to claim 2, wherein the water-soluble silicon resin includes one of:
siloxane having a SiH bonding and
a compound obtained by one of:
substituting a part of hydrogen in the bonding with halogen atoms of chlorine (Cl), bromine (Br), or fluorine (F) or alkali metals of sodium (Na) or potassium (K), and
substituting ½ or less of hydrogen in the bonding with a linking group of an organic compound.

12. The method of manufacturing a solid type secondary battery according to claim 3, wherein the water-soluble silicon resin includes one of:
siloxane having a SiH bonding and
a compound obtained by one of:
substituting a part of hydrogen in the bonding with halogen atoms of chlorine (Cl), bromine (Br), or fluorine (F) or alkali metals of sodium (Na) or potassium (K), and
substituting ½ or less of hydrogen in the bonding with a linking group of an organic compound.

13. The method of manufacturing a solid type secondary battery according to claim 4, wherein the water-soluble silicon resin includes one of:
siloxane having a SiH bonding and
a compound obtained by one of:
substituting a part of hydrogen in the bonding with halogen atoms of chlorine (Cl), bromine (Br), or fluorine (F) or alkali metals of sodium (Na) or potassium (K), and
substituting ½ or less of hydrogen in the bonding with a linking group of an organic compound.

14. The method of manufacturing a solid type secondary battery according to claim 2, further comprising a step of manufacturing a positive electrode charge-collecting print layer and a negative electrode charge-collecting print layer by mixing one of graphite powder and graphite fiber powder of 100 parts by weight with a binder of water-soluble silicon resin of 1 to 50 parts by weight and a water-based solvent of 10 to 100 parts by weight, wherein, in the printing step (2), the positive electrode charge-collecting print layer is printed on an outer side of the positive electrode print layer, and the negative electrode charge-collecting print layer is printed on an outer side of the negative electrode print layer.

15. The method of manufacturing a solid type secondary battery according to claim 3, further comprising a step of manufacturing a positive electrode charge-collecting print layer and a negative electrode charge-collecting print layer by mixing one of graphite powder and graphite fiber powder of 100 parts by weight with a binder of water-soluble silicon resin of 1 to 50 parts by weight and a water-based solvent of 10 to 100 parts by weight, wherein, in the printing step (2), the positive electrode charge-collecting print layer is printed on an outer side of the positive electrode print layer, and the negative electrode charge-collecting print layer is printed on an outer side of the negative electrode print layer.

16. The method of manufacturing a solid type secondary battery according to claim 4, further comprising a step of manufacturing a positive electrode charge-collecting print layer and a negative electrode charge-collecting print layer by mixing one of graphite powder and graphite fiber powder of 100 parts by weight with a binder of water-soluble silicon resin of 1 to 50 parts by weight and a water-based solvent of 10 to 100 parts by weight, wherein, in the printing step (2), the positive electrode charge-collecting print layer is printed on an outer side of the positive electrode print layer, and the negative electrode charge-collecting print layer is printed on an outer side of the negative electrode print layer.

17. The method of manufacturing a solid type secondary battery according to claim 2, further including the step of mixing a conductive filler in the nonaqueous electrolyte print layer.

18. The method of manufacturing a solid type secondary battery according to claim 3, further including the step of mixing a conductive filler in the nonaqueous electrolyte print layer.

19. The method of manufacturing a solid type secondary battery according to claim 4, further including the step of mixing a conductive filler in the nonaqueous electrolyte print layer.

20. The method of manufacturing a solid type secondary battery according to claim 2, wherein each of the print layers separated between rollers is stacked on both sides of a release sheet moved by a roller.

21. The method of manufacturing a solid type secondary battery according to claim 3, wherein each of the print layers separated between rollers is stacked on both sides of a release sheet moved by a roller.

22. The method of manufacturing a solid type secondary battery according to claim 4, wherein each of the print layers separated between rollers is stacked on both sides of a release sheet moved by a roller.

23. The method of manufacturing a solid type secondary battery according to claim 14, wherein after the drying step (3), the positive and negative electrode print layers have a thickness of 10 to 20 mm, the nonaqueous electrolyte print layer has a thickness of 50 to 150 mm, and the positive and negative charge-collecting print layers have a thickness of 5 to 10 mm.

24. The method of manufacturing a solid type secondary battery according to claim 15, wherein after the drying step (3), the positive and negative electrode print layers have a thickness of 10 to 20 mm, the nonaqueous electrolyte print layer has a thickness of 50 to 150 mm, and the positive and negative charge-collecting print layers have a thickness of 5 to 10 mm.

25. The method of manufacturing a solid type secondary battery according to claim 16, wherein after the drying step (3), the positive and negative electrode print layers have a thickness of 10 to 20 mm, the nonaqueous electrolyte print layer has a thickness of 50 to 150 mm, and the positive and negative charge-collecting print layers have a thickness of 5 to 10 mm.

26. A solid type secondary battery manufactured by the method according to claim 2.

27. A solid type secondary battery manufactured by the method according to claim 3.

28. A solid type secondary battery manufactured by the method according to claim 4.
